(19) United States
(12) Patent Application Publication
(10) Pub. No.: US 2026/0236993 A1
(43) Pub. Date: Aug. 13, 2026

(54) User Control Of Multiple Artificial Intelligence Systems

(71) Applicants: Raymond M. Galasso, Austin, TX (US); Joseph Simko, Sterling Heights, MI (US); Eric S. Smith, Waterford, MI (US)

(72) Inventors: Raymond M. Galasso, Austin, TX (US); Joseph Simko, Sterling Heights, MI (US); Eric S. Smith, Waterford, MI (US)

(21) Appl. No.: 19/471,005

(22) PCT Filed: Jun. 3, 2023
(86) PCT No.: PCT/IB2023/055718

§ 371 Date: Sep. 30, 2025

(51) Int. Cl. G06Q 40/06

(52) U.S. Cl. CPC G06Q 40/0631

(57) ABSTRACT

A method, system, and computer program product are disclosed for user control of multiple AI (Artificial Intelligence) systems. One or more decision engines use a hierarchical weighting structure including a plurality of decision criteria and a plurality of decision factors including user controlled and weighted multiple AI System inputs to objectively assess and/or comparatively evaluate choices. A composite choice score is derived from decision factor scores and the corresponding relative weighting value for decision criteria for each one of the choices. A user controls each AI system by selecting/adjusting weighting values for decision factors and/or decision criteria associated with each AI system and a comparative assessment or analysis for the choices is generated based on the user weightings and resulting composite choice scores.

### FIELD OF THE DISCLOSURE

This disclosure relates to artificial intelligence (hereinafter “AI”). More specifically, it relates to user control of multiple AI systems.

### BACKGROUND

The present disclosure recognizes the fears of out-of-control AI systems leading to “nonhuman minds that might eventually outnumber, outsmart, obsolete and replace us.” See Metz, Cade, and Gregory Schmidt. “Elon Musk and Others Call for Pause of A.I., Citing ‘Profound Risks to Society’.” The New York Times, 29 Mar. 2023, https://www.nytimes.com/2023/03/29/technology/ai-artificial-intelligence-musk-risks.html and “Pause Giant AI Experiments: An Open Letter.” 22 Mar. 2023, https://futureoflife.org/open-letter/pause-giant-ai-experiments/. Additionally, there are shortcomings, problems and fundamental structural and other differences associated with different AI systems each generating possibly different answers to the same question or request by a user. In one example, each AI system can have different back-end training. In another example, it is not known which AI systems and associated platforms, networks, nodes or devices have the “best” answer. Additionally, it has been well publicized that AI systems can have built in biases which are not known to or controllable by a user. Such AI systems can each have different operating systems and learning techniques or processes, and an AI system can automatically be learning based on the usage pattern of a particular device or user base. The learning pattern of an AI systems can be dependent on, for example, different types of parameters which were considered during the learning process, types of scenarios which were addressed by the device, and an amount of learning, as well as other parameters. This can result in different devices of the same category (different AI systems) learning differently when the learning parameters are different, and/or when the scenarios addressed are different, or when an AI algorithm is different. Therefore, in any multi-AI device or system scenario, there is a need for user control of the AI devices or systems, to provide the best possible decision or answer based on a user's selection and control of multiple AI devices or systems. There is also a need for human user control of the influence of AI devices or systems on individual decision making to avoid AI devices or systems controlling individual decision making and/or becoming sentient or controlling humans such that nonhuman minds do not “eventually outnumber, outsmart, obsolete and replace us.”

### SUMMARY

Implementations described herein address the problems or issues by allowing multiple AI systems or inputs to be suggested, selected, weighted to contribute to and influence the scoring and ranking of choices and or desired outcomes (or those to be avoided) to the extent determined by the user, importantly, giving the user control over the influence of the different AI systems or inputs in decision making.

In accordance with one embodiment of the inventive disclosures made herein, a computer system comprises a computer processor, a computer-readable storage medium, and program instructions stored on the computer-readable storage medium being executable by the processor, to cause the computer system to perform a method for user control of multiple AI systems for objectively quantifying choices, comprising communicating and interacting with multiple AI systems; using a hierarchical weighting structure including a plurality of decision criteria and a plurality of decision factors wherein the output of each of said multiple AI Systems are one of the decision factors selected to provide a desired composite effect; selecting a weighting value for each one of said decision criteria and for each one of said decision factors selected to provide the desired effect; providing a plurality of choices on which to perform a comparative assessment or analysis;
generating a composite score and relative ranking for each each one of said choices, wherein
the score for each is derived from the composite blend of said
decision factor values and the corresponding relative weighting value; all of which derive a composite choice score from said decision factor scores and the corresponding relative weighting value for each one of said decision criteria for each one of said choices; and providing a comparative assessment for the plurality of choices at least partially based on the composite choice scores.

In accordance with another embodiment of the inventive disclosures made herein, a system for comparatively assessing investment choices, comprising at least one data processing device; instructions processable by said at least one data processing device; and an apparatus from which said instructions are accessible by said at least one data processing device; wherein said instructions are configured for causing said at least one data processing device to provide a hierarchical weighting structure including a plurality of performance criteria and a plurality of performance factors selected to provide a desired investment effect, wherein a first group of said performance factors subtends from a first one of said performance criteria, a second group of performance factors subtends from a second one of said performance criteria, the plurality of performance criteria comprises at least risk and return (along with other distinguishing characteristics) associated with said investment choices, and the plurality of performance factors are at least time-based measurements of said performance criteria; provide a relative weighting value for each one of said performance criteria and for each one of said performance factors selected to provide the desired investment effect; provide a plurality of investment choices on which to perform a comparative assessment; provide a factor value corresponding to each one of said performance factors and other distinguishing features for each one of said investment choices; derive a composite investment performance score from said performance factor and the corresponding relative weighting value for each one of said performance criteria for each one of said investment choices; initiate, using one or more AI systems, a due diligence review for said investment choices; and provide a comparative assessment for the plurality of investment choices at least partially based on the composite investment performance scores and rankings and the AI system-based due diligence review.

In accordance with another embodiment of the inventive disclosures made herein, a system for comparatively assessing investment choices, comprising at least one data processing device; instructions processable by said at least one data processing device; and an apparatus from which said instructions are accessible by said at least one data processing device; wherein said instructions are configured for causing said at least one data processing device to: create, using one of more AI systems, one or more model portfolios for investment choices; provide a hierarchical weighting structure including a plurality of performance criteria and a plurality of performance factors selected to provide a desired investment effect, wherein a first group of said performance factors subtends from a first one of said performance criteria, a second group of performance factors subtends from a second one of said performance criteria, the plurality of performance criteria comprises at least risk and return associated with said investment choices, and the plurality of performance factors are at least time-based measurements of said performance criteria; provide a relative weighting value for each one of said performance criteria and for each one of said performance factors selected to provide the desired investment effect; provide a plurality of investment choices, dependent on the one or more model portfolios, on which to perform a comparative assessment; provide a performance factor value corresponding to each one of said performance factors for each one of said investment choices; derive a composite investment performance score from said performance factor values and the corresponding relative weighting value for each one of said performance criteria for each one of said investment choices; and provide a comparative assessment ranking the plurality of investment choices, for each model portfolio, at least partially based on the composite investment performance scores.

These and other objects of the invention will be apparent to those skilled in the art. The foregoing and other features and advantages of embodiments of the present invention will be more readily apparent from the following detailed description. The detailed description proceeds with references to the accompanying drawings.

### BRIEF DESCRIPTION OF THE DRAWINGS

Embodiments of the present disclosure are described with reference to the following drawings, wherein:

FIG. 1 depicts an information flow schematic in accordance with an embodiment of the inventive disclosures made herein.

FIGS. 2A and 2B depict a method for facilitating financial consulting services in accordance with embodiments of the disclosures herein and in view of the information how schematic depicted in FIG. 1.

FIG. 3 depicts an embodiment of the operation for determining the investment choices depicted in FIG. 2.

FIG. 4 depicts an embodiment of the operation for enabling the comparative performance assessment of the portfolio investments or choicesdepicted in FIG. 2.

FIG. 5 is a chart depicting a graphical representation of performance scores in accordance with an embodiment of the inventive disclosures made herein.

FIGS. 6A and 6B jointly depict an alternate embodiment for presenting the information depicted in the chart of FIG. 5.

FIG. 7 depicts a table having a plurality of multi-segment bars that graphically represent corresponding composite scores.

FIG. 8A depicts an embodiment of a weighting approach configured for facilitating a performance assessment in accordance with the inventive disclosures made herein.

FIGS. 8B and 8C depict an embodiment of a hierarchical weightings structure in accordance with the inventive disclosures made herein.

FIG. 9 depicts a network system configured for facilitating financial consulting services functionality in accordance with embodiments of the inventive disclosures made herein.

FIG. 10 is a schematic block diagram illustrating an overview of a system and methodology for user control of multiple AI (Artificial Intelligence) systems.

FIG. 11 depicts an information flow schematic in accordance with an embodiment of the inventive disclosures showing multiple AI systems, decision engines and inputs made herein.

### DETAILED DESCRIPTION

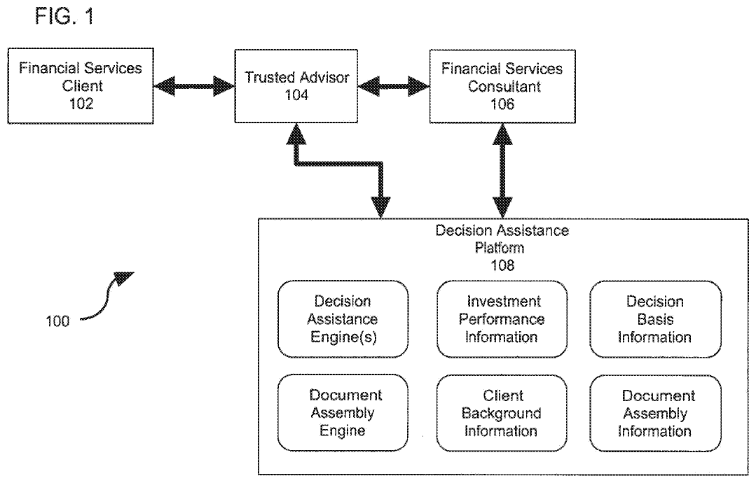

An embodiment of an information flow schematic 100 in accordance with the inventive disclosures made herein is depicted in FIG. 1. Entities within the information flow schematic include a financial services client 102, a trusted advisor 104 (i.e., an affiliated trusted advisor), a financial services consultant 106 and a decision-assistance platform 108 (i.e., a system). Communication of information (e.g., client background information and/or client-specific consulting information) is carried out between the financial services client 102 and the trusted advisor 104. Similarly, communication of information (e.g., client background information and/or client-specific consulting information) is carried out between the trusted advisor 104, the financial service consultant 106 and the decision-assistance platform 108. It will be appreciated that a client 102, individual investor or user may choose to not use trusted advisor 104, financial services consultant 106, other advisor or any third party and the role, capacity or functions described may be carried out by the client 102 or an individual investor or user directly. In other words, the client 102 or an individual investor or user may directly interact and use the decision-assistance platform 108 or other inventive embodiments described herein.

In the embodiment of the information flow schematic 100 depicted in FIG. 1, the trusted advisor 104 is a separate person/entity from the financial services consultant 106 and isolates the financial services client 102 from direct interaction with the financial services consultant 106 and the decision-assistance platform 108. In another embodiment (not specifically shown), the trusted advisor 104 and the financial services consultant are the same person (e.g., an attorney, CPA or family member), whereby that same person isolates the financial services client 102 from in-depth and/or direct interaction with the decision-assistance platform 108. In still another embodiment (not specifically shown), the trusted advisor 104 and the financial services consultant are different persons acting on behalf of the financial services client 102 from within a common organization (e.g., an attorney and CPA employed by a common local, national or international consulting firm), whereby the common organization isolates the financial services client 102 from in-depth and/or direct interaction with the decision-assistance platform 108.

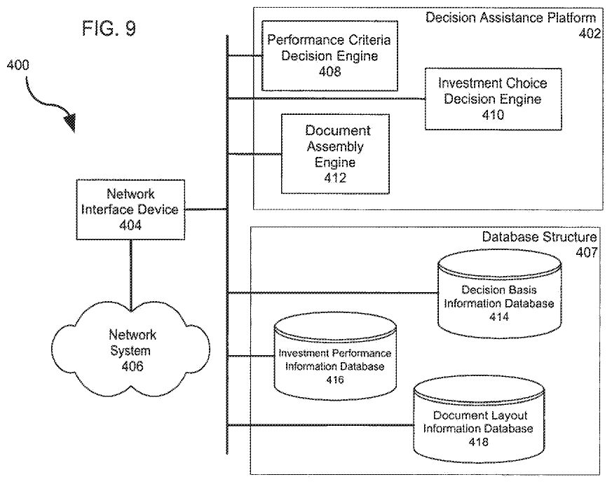

It is disclosed herein that interaction and communication between the financial services client 102, the trusted advisor 104 (i.e., an affiliated trusted advisor), the financial services consultant 106 and/or directly between the individual investor and the decision-assistance platform 108 may be implemented via networked computer system(s). For example, via the network system 400 depicted in FIG. 9, such interaction and communication may be facilitated via a networked computer system. The Internet is one embodiment of such a networked computer system. As such, it is disclosed herein that a website may be provided for enabling such interaction and communication. Specific examples of such interaction and communication include, information acquisition functionality (e.g., receiving background information from the client and/or individual investor), service payment functionality (electronically receiving payment for services), distributed processing functionality (e.g., where various decision assistance functionality is performed in a distributed manner), consulting information delivery functionality (e.g., providing client-specific consulting information such as objectively-quantified and/or ranked investment choices and client/individual investor-specific reports to the client/individual investor and/or trusted advisor), etc.

The decision-assistance platform 108 accesses and/or is provided information about, for example, the client/individual investor (e.g., the client's/individual investor's life circumstances, investment preferences, financial position, financial goals, risk tolerances, etc.), decision basis information (including, without limitation, asset allocation technology and rule set), investment performance information (both with regard to all available product/investment choices and client/individual investor-specific, historic performance information) and document format template information for performing associated decision assistance functionality. In one embodiment, information utilized in carrying out decision assistance functionality as disclosed herein (e.g., manually and/or by a decision-assistance platform) is stored in and accessible from one or more databases. Examples of decision assistance functionality, as discussed below in greater detail, include inputting, compiling and/or determining information comprised by a client/individual investor-specific template and determining client/individual investor-specific consulting information (e.g., determining client/individual investor-specific investment choices) at least partially dependent upon decision basis information. Examples of such decision basis information include information relating to prescribed decision-making rules, information relating to investment effect selection and information relating to correlating investments opportunities to client financial needs, desires and/or goals. Examples of investment performance information include information associated with returns on an investment, information associated with risk of an investment, information associated with other performance and distinguishing characteristics of an investment (e.g., manager tenure, turnover ratio, focus, internal fee/cost structures, etc.) and information associated with compiling comparative analyses of performance and structural data. Examples of document format information include information associated with formatting prescribed documents, content included within prescribed documents and information associated with outputting information related to making investment choices (e.g., creating a printed document including such information and/or displaying such information). Decision basis information, investment performance information, and document format information are examples of client/individual investor-specific investment related information in view of a particular client/individual investor and facilitating decision assistance functionality in accordance with the inventive disclosures made herein. It will be appreciated that the inventive embodiments contemplate allowing an individual investor or user to bypass any financial advisors or consultants to directly empower the investor or user to make investment choices/selections.

In accordance with at least one embodiment of the inventive disclosures made herein, decision assistance functionality disclosed herein is carried out by a decision-assistance platform that comprises a first decision engine (e.g., a rules-based expert system) and a second decision engine (e.g., an investment selection optimization system). The first decision engine facilitates creation of a client/individual investor-specific template that represents a client/individual investor-specific profile comprising various information (e.g., rules, data sets, processing instructions, performance criteria, etc.). Examples of such information comprised by the client/individual investor-specific template include performance weightings and factors (e.g., parameters corresponding to investment effects desired by the client), defined data and/or datasets, logic conditional filters for designating manipulation (e.g., refining/slimming datasets) of datasets, and processing instructions. The processing instructions represent information that enables tasks such as proper utilization of factors, weightings, and filters to be facilitated, that enables document assembly functionality to be facilitated (e.g., auto-mated report generation) and information related to recursive analysis/assessment of investment information. Information comprised by the client/individual investor-specific template is utilized by the second decision engine to facilitate scoring and ranking processes for optimizing investment selection (i.e., generating investment choices) in a manner consistent with a client's individual needs, goals and desires. Such instructions include information relating to appropriate percentage allocation of investments among available asset classes (i.e., the asset allocation), to appropriate blending of performance factors and/or to appropriate weighting of such factors for the comparative analysis of choices within each such asset class. The scoring and ranking processes includes enabling assessment of investment choices in a manner that is intended to aid a client/individual investor in identifying which money management teams (e.g., mutual funds and ETFs) have historic performance that most closely matches the investment experiences that the client desires (i.e., the ideal investment effect the client desires and is seeking).

It is disclosed herein that a person may perform, in a manual fashion, certain decision assistance functionality dis-closed herein as being facilitated by the decision-assistance platform rather than such functionality being performed by the decision-assistance platform. In one example, functionality of disclosed herein as being facilitated by the first decision engine of the decision-assistance platform is at least partially facilitated by a person in a manual manner and resulting information is subsequently made available to the decision-assistance platform for enabling functionality of the decision-assistance platform to be facilitated (e.g., functionality facilitated by the second decision engine of the decision-assistance platform). In one specific example, client/individual investor-specific template information is at least partially generated in a manual manner rather than by a decision engine of the decision-assistance platform.

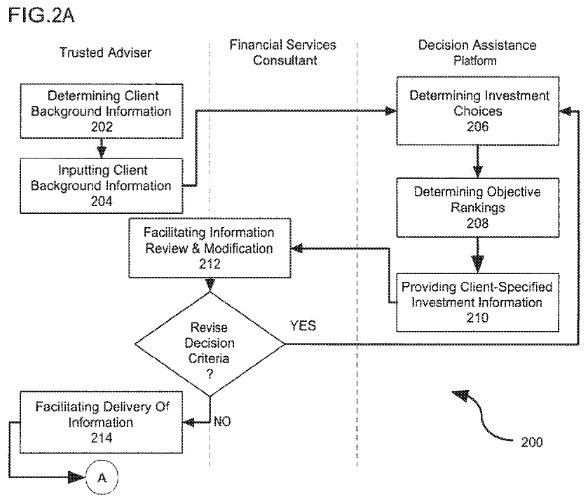

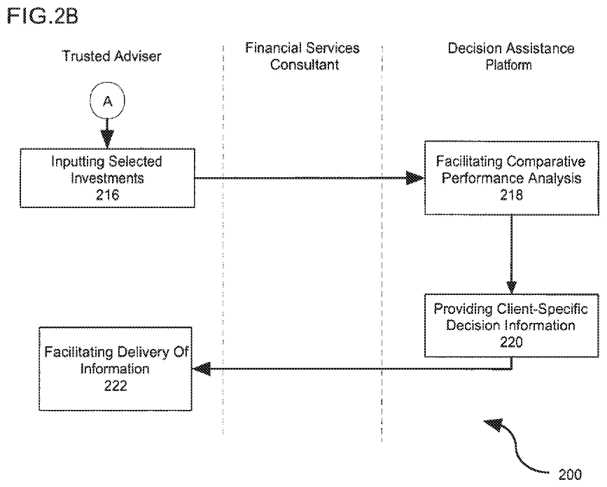

FIGS. 2A and 2B depict a method 200 for facilitating financial consulting services and/or the direct assistance to individual investors in accordance with embodiments of the disclosures herein and in view of the information flow schematic 100 depicted in FIG. 1. An operation 202 is performed for obtaining client//individual investor background information, such as in response to a meeting with the financial services client or the direct interaction of an individual investor with the decision-assistance platform through an appropriate networking interface. After obtaining the client/individual investor background information, an operation 204 is performed for inputting relevant and/or required client background information into a decision-assistance platform. Inputting such information, whether directly by an individual investor or through an advisor intermediary is an embodiment of enabling access of such information.

In response to inputting the client/individual investor financial objectives, the decision-assistance platform performs an operation 206 for determining investment choices (e.g., an appropriate asset allocation) that correspond to the client's/individual investor's financial objectives. After determining the investment choices (e.g., asset allocation), the decision-assistance platform performs an operation 208 for determining an objective ranking (i.e., an objective quantification) of the computed/comparatively evaluated investment choices (i.e., an operation that objectively scores and ranks, in a manner specific to that client/individual investor, all available investment choices within the various asset classes of investment choices computed in operation 206), thereby producing objectively ranked investment choices. In at least one embodiment of the inventive disclosures made herein, determining the objective ranking includes objectively and client/individual investor-specifically determining a performance score (discussed below in greater detail) for each of the investment choices and ranking the investment choices dependent upon information derived from the client/individual investor-specific performance scores.

In one embodiment, determining the investment choices includes applying a logic conditional filter to at least one of potentially many performance factors and other distinguishing characteristics expressed as numeric information, alphanumerical information and/or date information. For example, such a conditional filter is used for omitting funds that are closed (i.e., not accepting investments from new investors), or that have other distinguishing or situational characteristics (i.e., factors) that are not desired or appropriate (e.g., investment amount exceeds an investment amount prescribed) for a client. In one embodiment, determining investment choices includes determining the investment choices dependent upon information derived from different aspects of the client/individual investor-specific template (i.e., different client/individual investor-specific template information). Such determining is, in at least one embodiment of the inventive disclosures made herein, performed by a first decision engine of the decision-assistance platform, whereby resulting information compiled by the first decision engine is subsequently provided to the second decision engine of the decision-assistance platform, thus enabling a scoring and ranking process to be carried out by the second decision engine. In one embodiment, the client/individual investor-specific template includes one or more of potentially many filters and weightings, with one or more of the filters and weightings being applied to performance factor information, client/individual investor information, investment opportunity information, and/or investment performance information, AI inputs, and other information.

After determining the objective ranking, the decision-assistance platform performs an operation 210 for providing client/individual investor-specific consulting information (e.g., investment choices, objective quantification thereof, etc.). In one embodiment, such providing the client/individual investor-specific consulting information includes preparing and outputting a client/individual investor-specific investment report by a document assembly engine of the decision-assistance platform. In another embodiment, providing the client/individual investor-specific consulting information includes visually displaying such information. In another embodiment, such providing includes making such information accessible for related operations (not necessarily or specifically shown) of the method 200. Accordingly, it is disclosed herein that the decision-assistance platform is preferably configured for preparation and output of information as printed and/or electronic documents (i.e., reports that are configured for being printed and/or electronically displayed).

The client/individual investor-specific investment report as disclosed herein documents client/individual investor-specific consulting information such as objectively ranked investment choices. Such client/individual investor-specific consulting/investment related information (e.g., objectively ranked investment choices) is, preferably, presented in view of multiple variables that are dependent upon information derived from the financial objectives of the client/individual investor. For example, various scenarios of investment choices may be presented that are dependent upon information derived from a plurality of desired investment effects and related computed performance scores. Such investment effects are dependent upon information derived from performance criteria. Broadly, performance criteria in accordance with the inventive disclosures made herein include criteria relating to return, risk, associated industry-prescribed asset classes, investment effect rules and correlating investments opportunities to client/individual investor expectations. Specific examples of performance criteria and their related performance factors are depicted below in Table 1. Detailed information defining such performance criteria and their related performance factors are not discussed in detail but would be understood by a person skilled in the related art (e.g., financial systems and methodologies).

TABLE 1
Performance Criteria and related Performance Factors

| Performance Criteria | Related Performance Factors |
|---|---|
| Annualized Return | N-Year Return, N-Year |
| | Average Return |
| Annualized Standard | N-Year Standard Deviation, |
| Deviation | N-Year Annualized SD |
| Index | Index Score, Composite |
| | Index Score |
| Yield | N-Year Yield |
| Beta | N-Year Beta |
| Market Capitalization | Average Market |
| | Capitalization |
| Sharpe Ratio | N-Year Sharpe Ratio |
| Turnover Ratio | N-Year Turnover Ratio |
| Treynor Ratio | N-Year Treynor Ratio |

In at least one embodiment of the client/individual investor-specific investment report, the client/individual investor-specific investment report includes charts and tables depicting investment allocation among various asset classes, statistical/historical performance of investment choices within various asset classes, distribution of composite performance scores for such investment choices, and client/individual investor-specific scoring and ranking of such investment choices. In at least one embodiment, the client/individual investor-specific investment report includes a client/individual investor-specific assessment or comparative analysis of available investment alternatives dependent upon information derived from a comparative analysis of such available investment alternatives.

After reviewing the client-specific consulting information, the trusted advisor and/or the financial services consultant (in consultation with the client) may facilitate an operation 212 for revising decision criteria upon which the objective ranking of investment choices is based. Such revisions include revisions to performance criteria (e.g., factor selections and weightings) and modifying/clarifying information associated with client financial objectives. This may also be done by the individual investor directly through the individual investor's direct access to the decision-assistance platform. In response to the trusted advisor and/or the financial services consultant or the individual investor's revising any of the decision criteria, the method precedes at the operation 206 for determining investment choices an objective-ranking (i.e., operation 208) dependent upon information derived from the revised criteria. In response to neither the trusted advisor nor the financial services consultant nor the individual investors' revising any of the decision criteria, the method continues at an operation 214 for facilitating delivery of the client/individual investor-specific consulting/investment-related information (e.g., in the form of a client/individual investor-specific investment report) to the financial services client (e.g., the trusted advisor initiating electronic submission of the information by the decision-assistance platform or the trusted advisor personally facilitating presentation of the information) or directly to the individual investor. After the financial services client/individual investor selects one or more investment choices into which funds are to be allocated (e.g., after consultation with the trusted adviser), an operation 216 is performed (e.g., by the trusted advisor or financial services client or by the individual investor) for inputting the selected investment choices into the decision-assistance platform. Once funds are allocated, the selected investment choices represent an investment portfolio of the financial services client.

Periodically (e.g., quarterly), an operation 218 is performed via the decision-assistance platform for facilitating a comparative performance assessment of the investment choices within the portfolio, thereby generating periodic performance information (i.e., client/individual investor=—specific decision assistance information). As discussed below in greater detail, the comparative performance assessment provides information for qualitatively and objectively assessing selected investment choices. After facilitating the comparative performance assessment of the investment portfolio, the decision-assistance platform performs an operation 220 for providing such client/individual investor-specific decision information for subsequent operations. One example of enabling such subsequent operations includes outputting of a periodic performance report comprising such periodic performance information at the request of the trusted adviser or directly by the individual investor. In one embodiment, the periodic performance report is prepared and outputted by a document assembly engine of the decision-assistance platform. After performing the operation 220 for providing such client/individual investor-specific decision-assistance information, the trusted advisor performs an operation 222 for facilitating providing such information for review by the financial services client or the individual investor does so directly, without the intermediation of an advisor.

While, a decision-assistance platform as disclosed herein can play no role between a trusted advisor and an individual investor, in other embodiments, a decision-assistance platform as disclosed herein can play a role between the trusted advisor and an individual investor financial services client. For example, the decision-assistance platform may facilitate compilation of information directly from the financial services client or individual investor or may provide investment choice information directly to the financial services client or individual investor, all with or without the intermediation of a trusted advisor.

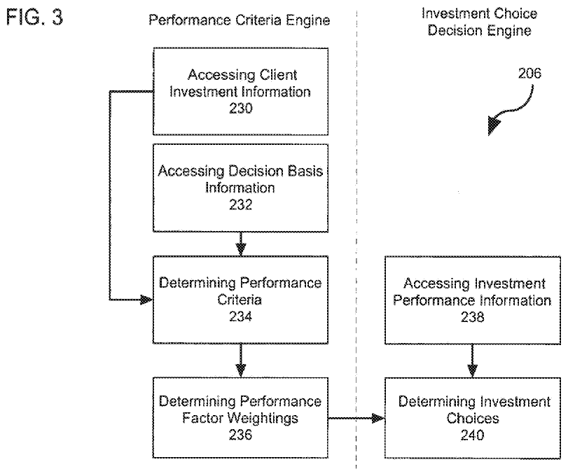

FIG. 3 depicts an embodiment of operation 206 for determining the investment choices. An operation 230 is performed by a performance criteria decision engine (i.e., a first decision engine) of the decision-assistance platform for accessing client background information and an operation 232 is performed by the performance criteria decision engine for accessing decision basis information. In one embodiment, client/individual investor background information and decision basis information are accessed from one or more databases by the performance criteria decision engine.

In response to the client background information and the decision basis information being accessed, an operation 234 is performed via the performance criteria decision engine for determining corresponding performance criteria (e.g., investment effect parameters). Examples of the corresponding investment effect parameters include parameters associated with risk of an investment, parameters associated with return on an investment, parameters associated with other structural and performance aspects, as well as other distinguishing characteristics of an investment, various investment allocation rules and parameters associated with correlating investment opportunities to client investment expectations. In at least one embodiment, the category of investment effect parameters includes investment allocation parameters. The performance criteria decision engine performs operation 236 for determining performance-weighting factors dependent upon information derived from the investment effect parameters in response to determining the investment effect parameters. For example, a performance factor weighting of 0.80 and 0.20 may be used to compute and apply 15 performance factors for risk minimization and return maximization, respectively. The 0.80/0.20 performance factor weighting ratio would correspond to a situation in which the client investment objectives indicate that the client is far more concerned with risk minimization than return maximization.

After determining the performance factor weightings, an investment choice decision engine (i.e. a second decision engine) of the decision-assistance platform performs an operation 238 for accessing investment performance information (e.g., risk, return, and other structural and performance information and other distinguishing characteristics), followed by the investment choice decision engine performing an operation 240 for determining investment choices dependent upon the client's/individual investor's individual investment needs, desires and/or goals. Preferably, the respective decision engines facilitate determining the performance selection and weighting factors, determining investment effect parameters, and determining an objective scoring and ranking of available investment choices without human intervention during the respective computation operations, but which the advisor, client, and/or individual investor would have the ability to override and control.

It is disclosed herein that functionality (e.g., operations) facilitated by the performance criteria decision engine (i.e., a first decision engine) of the decision-assistance platform may alternatively be facilitated manually by a person, rather than by the performance criteria decision engine. In such an embodiment, resulting information from the manually facilitated functionality is subsequently made available to the investment choice decision engine for enabling functionality of the investment choice decision engine to be facilitated.

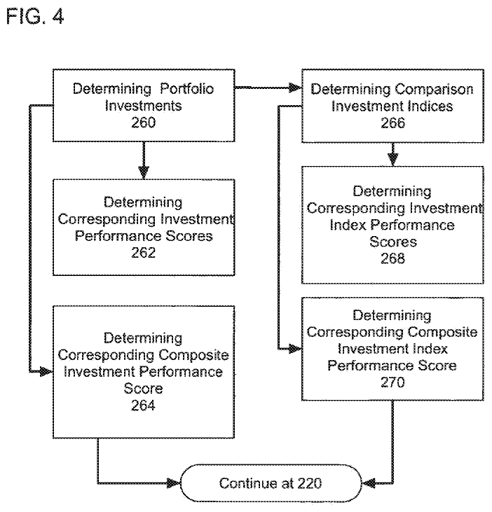

FIG. 4 depicts an embodiment of operation 218 for performing the comparative performance assessment of the investment portfolio. Operation 260 is performed for determining portfolio investments (i.e., the investment choices that presently comprise the client's/individual investor's portfolio). In response to determining the portfolio investments, an operation 262 is performed for determining a corresponding investment performance score for each of the portfolio's individual investments and an operation 264 is performed for determining a corresponding composite investment performance score. The composite investment performance score is a composite score that represents an overall performance of all of the individual portfolio investments.

After the portfolio investments are determined, an operation 266 is performed for determining benchmark investment indices corresponding to each one of the portfolio investments. The benchmark investment indices are those indices that suitably correspond to each of the portfolio investments (e.g., within a corresponding asset class, exhibiting corresponding performance factors, etc.). In response to determining the benchmark investment indices, an operation 268 is performed for determining a corresponding investment index performance score for each of the benchmark investment indices and an operation 270 is performed for determining a corresponding composite investment index performance score. The composite investment index performance score is a composite score that represents an overall performance of all of the individual investment indices. These individual and composite investment index performance scores are computed in the same manner (i.e., using the same performance factors and the same performance factor weightings) as is used in operations 262 and 264 described above. After determining the various performance scores, an operation 220 (FIG. 2B) is performed for providing such information for associated operations (e.g., for printing and/or displaying such periodic performance information).

It is contemplated that determining the composite investment index performance score may include combining the respective investment benchmark indices dependent upon information derived from actual allocations of funds within the corresponding investment portfolio and/or upon at least one of criteria relating to risk and criteria relating to return. Similarly, it is contemplated that determining the composite investment performance score may include combining the respective portfolio investments dependent upon information derived from actual allocations of funds within the corresponding investment portfolio and/or upon at least one of criteria relating to risk and criteria relating to return. Furthermore, it is disclosed herein that a decision engine system of the decision-assistance platform and/or a document assembly engine of the decision-assistance platform may perform the functionality of the operation steps of 218 for performing the comparative performance assessment of the investment portfolio.

Accordingly, scoring and ranking of all available investment choices within each asset class within the client's portfolio is performed. The scoring and ranking is performed using the same performance parameters and parameter weightings used in the original scoring and ranking analysis used by the client/individual investor to select the client's/individual investor's investment choices. The various related benchmark indices are scored and ranked in exactly the same manner as the investment choices within the asset class for which a particular index is relevant. The scoring process produces a composite numerical score for each of the client's/individual investor's investment choices, all other available (yet unchosen) investment choices, and the relevant indices.

These numeric scores, when used to sort the results of the scoring (e.g., from the highest composite score to the lowest composite score), effectively and quantitatively compare all investment choices with each asset class (both chosen and unchosen) as well as the relevant indices. The highest scoring and, therefore, the highest ranking of the choices are those whose blended composite score (i.e., the score resulting from the blending of all of the individually weighted performance factors used in the scoring process) indicate those choices the historic performance which most closely matches the investment performance desired by the client for a particular asset class being evaluated (i.e., the performance desired of that asset class, which was the reason for the inclusion of that asset class in the portfolio).

It is disclosed herein that the benchmark indices may correspond to asset classes corresponding to the individual portfolio investments. In such case, it is contemplated that the comparative performance assessment is performed between allocated investments (i.e., those selected investment choices that are funded) and a plurality of non-allocated investments represented by the asset class (i.e., all or a portion of the investment choices that were not selected for being funded).

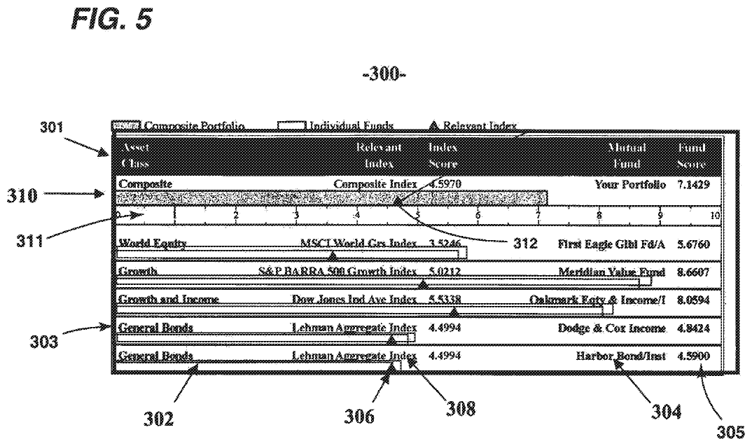

FIG. 5 is a chart 300 depicting a graphical representation of performance scores that are depicted in view of corresponding asset classes 301. In one example, chart 300 is comprised by a periodic performance report. The composite performance score 302 for each one of the asset classes 303 within the portfolio is depicted by a first configuration of graphical indicia (e.g., a corresponding horizontal bar of a first color). Depicted in association with individual managers and/or funds 304 is a composite score 305. The performance score 306 of each one of the investment indices 308 is depicted by a second configuration of graphical indicia (e.g., a discrete symbol of a first color) superimposed over the first configuration of graphical indicia. The composite investment performance score 310 is depicted by a third configuration of graphical indicia (e.g., a corresponding vertical bar of a second color). The composite index score 312 is depicted by a fourth configuration of graphical indicia (e.g., a triangle) superimposed over the third configuration of graphical indicia. In this manner, the selected investment choices of the financial services client//individual investor are graphically compared to appropriate benchmarks.

Chart 300 of FIG. 5 is configured to provide a summary of portfolio performance, using bar graphs to represent scores resulting from an assessment of the individual funds comprising the portfolio as well as the portfolio as a whole. The chart 300 provides a means for measuring overall portfolio performance, by comparing the “Composite Portfolio” score (i.e., the bar adjacent to the term “Composite”) with the “Composite Index” score (i.e., the triangle superimposed on the bar adjacent to the term Composite). As depicted, the composite portfolio bar extends beyond the location of the composite 30 index triangle. The positive differential indicated that the Composite Portfolio is outperforming the Composite Index in meeting stated performance goals. Chart 300 similarly depicts the performance of individual portfolio investments in relation to individual composite index components.

The graphical representation of the composite index score 310 is proportional to a blended score (i.e., discussed in the following paragraph in greater detail) of the portfolio and is positioned along a performance scale 311 such that its score can be compared to the composite index score 312 of the investment portfolio as a whole. The performance scale 311 serves as a means for measuring performance (e.g., scores) based on relative position of graphical representations depicting such scores. The graphical representation of each asset class performance score 302 is proportional to the composite score of individual fund (or manager) and is positioned on the performance scale 311 such a way that its each performance score 302 can be compared to its fund's relevant index score 306. The graphical representation of a fund's relevant composite score in relation to its index score 306 represents a way to measure the relative performance of the respective fund against its benchmark index.

The composite performance scores 302 for each individual fund and related asset class 303 provide a summary of the performance assessment performed on each of the portfolios' asset classes. Additionally, blending of the performance scores of the individual funds held is used in determining the composite investment performance score of the client's/individual investor's portfolio 310. The scores of relevant indices 308 are similarly blended and used in determining the composite index score 312. In one embodiment, such blending is accomplished by using current market value of client's/individual investor's holdings of a particular investment manager, mutual fund, or ETF and the proportional percentage of that holding with respect to the total value of the client's/individual investor's portfolio. For example, in an instance where the value of the client's//individual investor's holdings of a particular investment manager, mutual fund, or ETF is $5,000 and the total portfolio value is $100,000, 5% of the composite portfolio score 302 would be attributed to the composite investment score of that manager, mutual fund, or ETF. Furthermore, the same proportion of 5% would apply to the relevant benchmark index score and the blending determination of the composite index score.

Performance of a mutual fund, ETF, and/or money manager is typically considered within the context of a specific performance factor. For example, 5-year average annual return could be sorted to find out which manager had the highest return over any particular five-year period. However, when multiple performance factors (i.e., performance criteria used for decision making purposes) are used simultaneously to evaluate a mutual fund, ETF, and/or money manager's performance, the combining of each factor's performance is done in a manner that produces a composite score that can be used to evaluate the mutual fund, ETF, and/or money manager's overall performance. Once multiple performance criteria (which are functionally used as decision criteria) are selected, individual weightings can be assigned to each of the performance criteria so that the overall mutual fund, ETF, and/or money manager performance can be defined to the specific performance and decision requirements (e.g., needs, goals, risk tolerances, preference, etc.) of the financial services client/individual investor. Having a visual representation of how weighted performance criteria impact the composite scores is useful for quickly identifying which of the decision criteria are having the most impact on the composite scores.

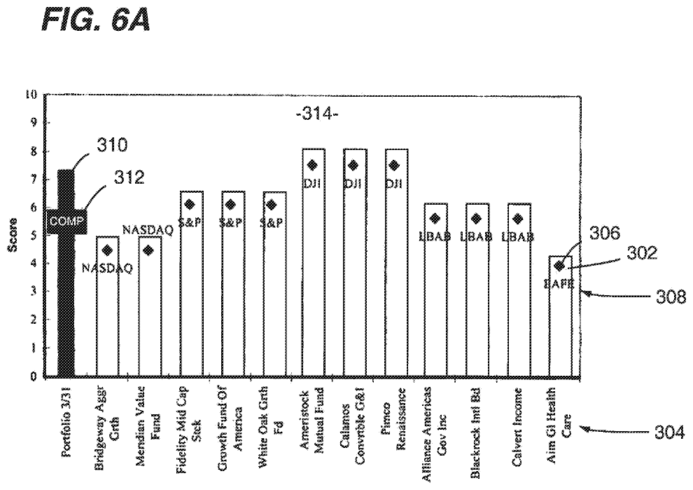

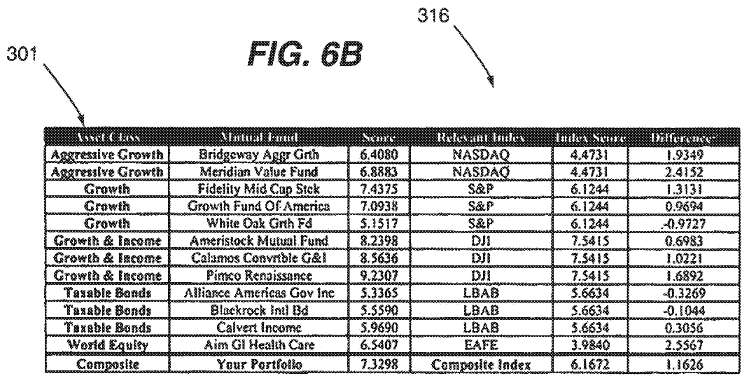

The chart 314 of FIG. 6A and the table 316 of FIG. 6B jointly depict an alternate embodiment for presenting the information depicted in the chart 300 of FIG. 5. While essentially the same information is presented in FIG. 5 as jointly depicted in FIGS. 6A and 6B, presentation in accordance with the chart of FIG. 5 is advantageous in that it allows a greater volume of information to be presented in a given amount of space (i.e., with respect to the presentation approach of FIGS. 6A and 6B).

It is disclosed herein that the charts depicted in FIGS. 5, 6A and 6B are examples of information configured for enabling objective and comparative assessment of investment choices to be made by an individual investor/financial services client. It is also disclosed herein that operations and/or approaches for generating all or a portion of the information comprised by the charts depicted in FIGS. 5, 6A and 6B are examples of assessing such information and/or enabling comparative assessment of such information.

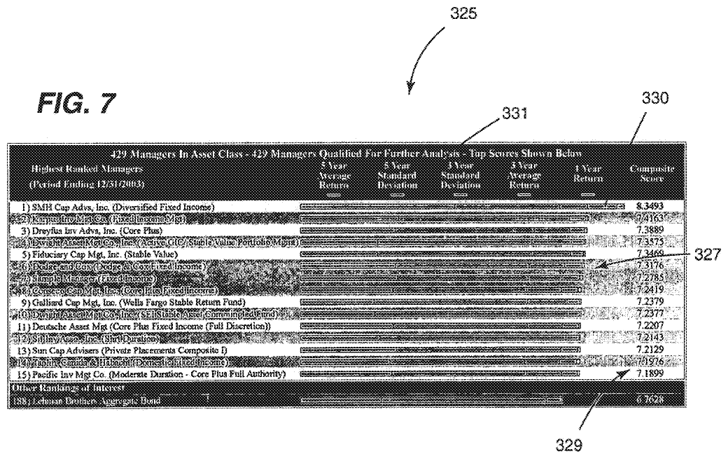

FIG. 7 depicts a table 325 having a plurality of multi-segment bars 327 (e.g., bars with different color segments) that each graphically represents a corresponding composite score. The lengths of each multi-segment bar 327 is proportional to its corresponding composite score 329 and, for comparison purposes, relative to all of the composite scores shown. The various segments 330 of each bar 327 represent the relative performance of the corresponding weighted performance criteria. The length of each segment 330 represents a performance criteria's weighted performance and impact on the overall performance score, as compared against a group of its peers within the same asset class. Longer segments proportionally represent a larger impact on the composite score. The order of the segments of each bar match the display order of the performance criteria labels 331 (e.g., 5-year return) in the header section of the table 325. However, in certain instances, a particular segment of a particular bar will not be depicted, representing that a manager is either missing data for the corresponding performance criteria or that a combination of minimal weighting and/or poor performance has caused that performance criteria to have little to no impact on the corresponding composite score.

Relative performance of performance criteria (i.e., criteria utilized for making investment decisions) in accordance with the inventive disclosures made herein may be assessed relative to one or more points of reference. Relative performance of decision criteria against all peers is a first point of reference. For example, comparing the length of the 5-Year Average Annual Return segments in the Table 325 of FIG. 7 indicates roughly a 35% difference in length favoring the top-rated manager, which is translated to same difference in performance as it relates to its peer group. Performance as it relates to the peer group is calculated using a scale of 5-Year Average Annual Return values. All of the performance criteria's peers define this scale and each performance score is applied to that scale to find its relative rank within the group. Because the graphical representation of performance takes each performance criteria's scale into consideration, it is useful for comparing performance criteria scores quickly. Thus, large differences in performance between mutual funds, ETFs, and money managers can be identified quickly and easily.

Relative performance of the performance criteria as it relates to the composite performance score is a second point of reference. Performance criteria weightings are not mentioned when evaluating the relative performance of performance criteria relative to all peers. This is because the weighting assigned to each performance criteria is applied equally to the group of peers. However, the weightings assigned to each 20 performance criteria directly influence determination of the composite score. For example, comparing the length of all the segments for the top manager shows that the majority of the weighting has been placed on the 5-Year Average Annual Return and 5-Year Average Annualized Standard Deviation. For this example, 80% of the weighting 25 is placed on the combination of those two performance criteria, which means that on a composite scoring scale of 0 to 10, these two performance criteria can add as much as 8 points to the composite score. Unlike the 5-Year performance criteria, the combined weightings of the 3-Year Average Annual Return and 3-Year 30 Average Annualized Standard Deviation are only weighted at 17.5%, which can add as much as 1.75 points to the composite score. The weighting assigned to each performance criteria acts as a multiplier that defines the maximum impact that the performance criteria can have on the composite score and also the 35 maximum length of the corresponding segment of the bar in Table 2. The effect of the weighting can be seen easily by comparing the sizes of the 5-Year performance criteria to the 3-Year performance criteria.

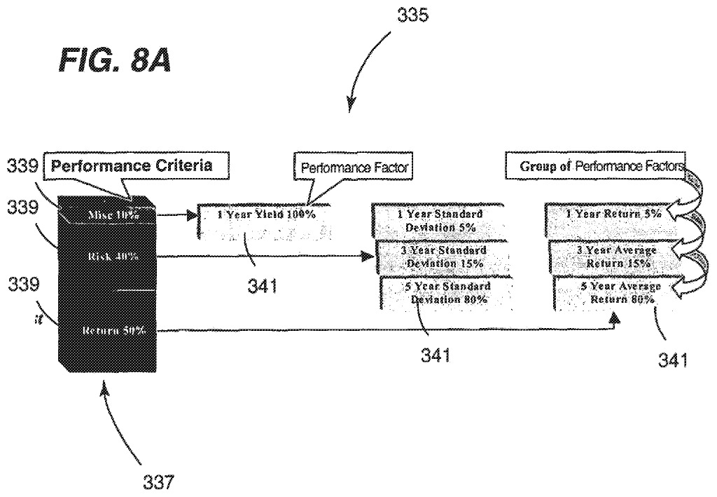

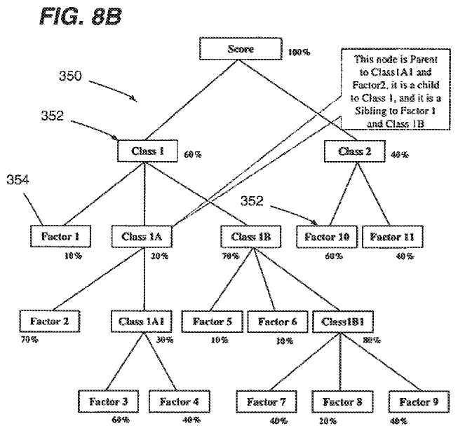

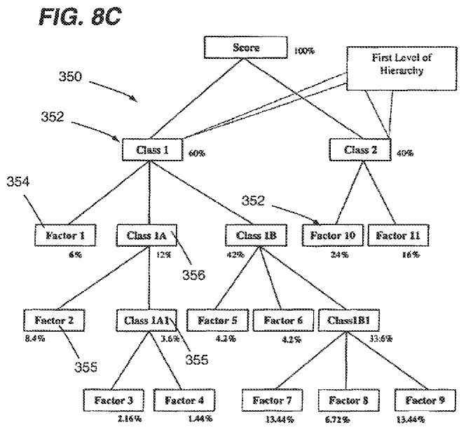

FIG. 8A depicts an embodiment of a weighting approach 40 335 for facilitating a performance assessment in accordance with the inventive disclosures made herein. The weighting approach 335 depicts a manner in which a performance assessment of managers is performed within each of the asset classes and shows a relationship of performance characteristics and performance criteria that have been used. The multi-segment vertical bar 337 depicts a grouping of performance criteria 339 used in the assessment and the degree of influence (i.e., weighting) assigned to each. Each one of the performance criteria 339 of the vertical bar 337 has one or more 50 subtending performance factors 341 associated therewith. The performance factors 341 that relate to common performance criteria 339 subtend from that particular performance criteria 339, thus producing groupings of performance factors in some instances.

Weightings are individually assigned to the performance factors 341 and indicate how much influence each of the performance factors 341 has within its group. Increasing any one performance factor's weighting within a group results in a corresponding decrease in the weighting assigned to the one or more other performance factors in the group. In effect, the sum of all of the performance factor weightings within a group must always sum to 100%. The same applies to the sum of all of the weightings applied to the performance criteria 339 from which all of the performance factors 341 subtend. Weighting of the various performance criteria 339 and performance factors 341 influence performance scores referred to herein. Specifically, each grouping of performance scores has a direct effect on a performance score. Because a 50% weighting has been applied to one of the performance criteria 339, that performance criteria will control 50% of a performance scale (e.g., 5 points of the 10-point scale). The individual performance factors 341 subtending from each performance criteria 339 have an indirect affect upon the performance score. That indirect effect is determined by multiplying the weight assigned to that performance factor 341 and the weight of the performance criteria 339 from which it subtends.

FIGS. 8B and 8C depict an embodiment of a hierarchical weightings structure that represents an approach for utilizing the weightings for determining performance scores. In effect, the weighting structure depicted in FIGS. 8B and 8C and the weighting approach 330 depicted in FIG. 8A accomplish the same objective and produce the same type of information. The difference is simply a matter of presentation.

The hierarchical structure includes a tree structure 350 where nodes 352 of the tree structure 350 are either classes or performance factors (depicted as ‘factor’ in FIGS. 8B and 8C) or other distinguishing characteristics, such as various AI and other inputs, such as pundit/expert opinions. The tree structure 350 serves to distribute weightings to the performance factors. The weightings assigned to the performance factors define the potential impact that a performance factor may have on the scoring and ranking performed during an assessment (e.g., the comparative performance assessment discussed above) of investment information.

Performance factors are the ‘leaves’ of the tree and correspond directly to the performance data and/or other relevant information (such as AI inputs, expert/pundit opinions, and other information regarding distinguish characteristics, all of which are included, collectively in the descriptive term “performance factors” as used herein) recorded in a corresponding dataset (i.e., inclusively/collectively described as “investment performance information”). Performance factors are always an end node 354 of any branch in the tree 350. As depicted in FIG. SB, ‘Class IA’ is a parent class node to ‘Factor 2’ (i.e., a child class node to ‘Class IA’), it is itself a child class node to ‘Class 1’ (i.e., the parent class node of ‘Class IA’) and it is a sibling class node to ‘Factor 1’ and ‘Class 18’ (i.e., the sibling class nodes of ‘Class IA’).

Classes are a group of performance factors or some combination of performance factors and classes. Only classes may be parent class nodes, but they can also be child class nodes or sibling class nodes. Factors may never be parent class nodes, and may only be child class nodes or sibling class nodes. Nodes on the same hierarchal level that are assigned to the same parent class node, will add up to 100%. Or, if they do not add to 100%, they are reduced to sum up to 100% while maintaining the weighting relationship between the assigned performance factors and classes. The performance factors that are assigned to classes are typically similar or share some common theme. The purpose of the classes is to have a way to quickly and easily influence the relative weightings of all the subtending classes and performance factors that have a relationship to a parent class.

All nodes 352 within the tree 350 have an assigned and/or a calculated weight. These weights can be assigned via a template, by manual entry or, through some other type of decision process (e.g., that of the performance criteria decision engine disclosed herein). It is necessary to normalize the weightings of all of the nodes 352 to 100%, so that their weightings are relative to subtending parent class nodes.

As depicted in FIG. 8C, actual weights are calculated based on the relative weightings of the nodes 352 in the weightings hierarchy. Actual weightings influence the scoring and ranking that takes place during an assessment of investment information. Each node's relative weight is multiplied by the actual weight of its parent node, which produces the actual weight of each one of the nodes 352. The hierarchy is processed from the highest node in the tree 350 to the lowest nodes in the tree, because the actual weight of parent class nodes is required to calculate the actual weight of its children (i.e., child class nodes). The actual weightings are then applied to investment performance data to generate a corresponding factor performance score. These individual factor performance scores are then combined to produce a composite performance score.

Using a hierarchical weighting structure is advantageous in that it enables the effect of different weighting scales to be blended. Blending such scales through the use of weighting allows evaluation of performance factor values using various different scoring methods. For example, in this way, blended investment index performance scores and a corresponding blended composite investment index performance score may be computed. As depicted in FIG. 8C, blended tree fragments 355 represent a plurality of performance factor weightings that sum to the weighting of a respective parent node 356.

FIG. 9 depicts a network system 400 (i.e., a data processing system) configured for facilitating financial consulting services functionality and individual investor empowerment in accordance with embodiments of the inventive disclosures made herein. The system 400 includes a decision-assistance platform 402, a network interface device 404 coupled to the decision-assistance platform 402, a network system 406 coupled to the network interface device 404. The decision assistance platform 402 comprises a database structure 407 accessible by the decision-assistance platform 402. Accordingly, communication of information between the decision-assistance platform 402 and other entities (e.g., a computer of a client, a computer of a financial services consultant and/or client and/or individual investor), a computer capable of downloading investment performance information, etc.) is enabled and accessibility of information required for carrying out such financial consulting services functionality and individual investor empowerment is enabled (e.g., via accessing a website from which such functionality is accessible).

The decision-assistance platform 402 includes a portfolio design and performance criteria decision engine 408 (i.e., a first decision engine), an investment choice decision engine 410 (i.e., a second decision engine) and a document assembly engine 412. The performance criteria decision engine 408 is an example of a means for carrying out performance weighting factor computation functionality as disclosed herein. Such computation of performance weighting factors may include information comprised by the client/individual investor-specific template (e.g., logic conditional filters and/or processing instructions).

In at least one embodiment of the inventive disclosures made herein, the first decision engine is configured for facilitating initial allocation functionality (e.g., facilitating appropriate client/individual investor-specific allocations of investments and investment effect parameters). The investment choice decision engine 410 is an example of a means for carrying out comparative scoring and ranking (i.e., quantification) of investment choices computation functionality as disclosed herein. A decision engine system of a decision-assistance platform is defined herein to comprise the portfolio design and performance criteria decision engine and the investment choice decision engine. The document assembly engine 412 is an example of a means for carrying out document preparation/outputting functionality as disclosed herein. It is contemplated that the various 60 engines may be physically embodied as separate or fully integrated software/hardware modules.

The database structure 407 includes a decision information database (which may include rules sets) 414, an investment performance information database 416, and client/individual investor information and document layout information database 418. In at least one other embodiment, separate client/individual investor information and document layout information databases are provided. Information (e.g., rules) upon which the decision-assistance platform 402 is dependent for carrying out performance criteria decision functionality as disclosed herein is maintained in the decision information database 414. Information upon which the decision-assistance platform 402 is dependent for carrying out scoring and ranking computation functionality (i.e., of investment choices) as disclosed herein is maintained in the investment performance information database 416. Information upon which the decision-assistance platform 402 is dependent for carrying out document preparation/outputting functionality as disclosed herein is maintained in the client/individual investor information and document layout information database 418. It is disclosed herein that, in at least one embodiment of the inventive disclosures made herein, the decision-assistance platform 402 is not a physically distinct apparatus or system. Rather, in such at least one embodiment, the decision-assistance platform 402 is a functional platform comprised by functionality imparted across a plurality of systems or system components (e.g., discrete functional blocks linked via a network system). Accordingly, it is disclosed herein that system elements configured for imparting such functionality may be or may not be located at a common location and may or may not reside on a common computer.

It is disclosed herein that, in at least one embodiment of the inventive disclosures made herein, the decision-assistance platform 402 comprises a single decision engine (e.g., a single data processing program) configured for facilitating all or a portion of the functionality of the portfolio design and performance criteria decision engine 408, an investment choice decision engine 410 and a document assembly engine 412. In one example, a single decision engine program running on a suitable data processing system facilitates all or a portion of the functionality of the portfolio design and performance criteria decision engine 408, an investment choice decision engine 410 and a document assembly engine 412 via a single data processing program. In another example, a single decision engine is fashioned to include various functional modules that interact to facilitate all or a portion of the functionality of the 408, an investment choice decision engine 410 and a document assembly engine 412.

Referring now to computer readable medium in accordance with embodiments of the inventive disclosures made herein, methods as disclosed herein are tangibly embodied by computer readable medium having instructions thereon for carrying out such methods. In one specific example, instructions are provided for carrying out the various operations of the method 100 depicted in FIGS. 2A and 2B for facilitating financial consulting services and individual investor empowerment. The instructions may be accessible by the decision-assistance platform from a memory apparatus of the decision-assistance platform (e.g. RAM, ROM, virtual memory, hard drive memory, etc.), from an apparatus readable by a drive unit of the decision-assistance platform (e.g., a diskette, a compact disk, a tape cartridge, etc.) or both. Examples of computer readable medium include a compact disk or a hard drive, which has imaged thereon a computer program for carrying out financial consulting services functionality/individual investor empowerment in accordance with embodiments of the inventive disclosures made herein.

Although the discussion of method and systems in accordance with embodiments of the inventive disclosures made herein have been presented thus far in view of financial utility to investors and their advisors, it is contemplated that such methods and systems may be configured specifically for providing utility in the areas of commercial and residential lending, venture capital funding, investment banking services. Furthermore, it is contemplated that such methods and systems may be configured for providing utility beyond financial services. Specifically, embodiments of the decision-assistance platform functionality disclosed herein may be applied in applications other than financial services. Retail e-commerce applications, market research applications, human resource applications, dating services and raw material procurement, sports and gaming, are examples of such applications where an objective and unbiased scoring and ranking assessment of all available choices (i.e., within any universe of choices, the differences among them which may be quantified) functionality, consistent with a client's (or consumer's) individual needs, goals and/or desires, provided by the decision-assistance platform functionality are useful. The inventive disclosures made herein relate to facilitating financial consulting services and individual investor empowerment. Methods and equipment in accordance with embodiments of the inventive disclosures made herein are configured for enabling quantitatively ranked investment choices to be offered to clients by trusted advisers (e.g., attorneys, lawyers, siblings, community bankers, and the like) who are not necessarily professionals within the traditional financial services industry. The trusted advisor is thus armed with the knowledge to coordinate all of their clients' financial services needs, not as product salespeople, but in their traditional role as the providers of independent advice. In doing so, the client is provided with an increased level of trust with respect to the financial information being provided and the person providing the financial information. Additionally, for those individuals without advisor assistance the methods and equipment in accordance with embodiments of the inventive disclosures made herein are configured for enabling quantitatively ranked investment choices to be made available directly to individual investors.

Methods in accordance with embodiments of the inventive disclosures made herein and system configured for carrying out such methods provide trusted advisors having access to such methods (i.e., affiliated trusted advisors) with a proprietary support arrangement including a decision-assistance platform. The proprietary decision-assistance platform enables the affiliated trusted advisors to advise their clients and to coordinate solutions to their needs, outsourcing the responsibility of product research, comparative assessment, implementation and acquisition. This unique outsourcing structure creates significant efficiencies and allows affiliated trusted advisors to largely confine their time to meeting with and advising their clients, which is the most important and best use of their time. It eliminates the need to refer clients away to brokers, insurance agents, and other product sales-people, allowing the affiliated trusted advisor to retain a large portion of revenues that they have traditionally referred away to such brokers, agents and salespeople.

Methods in accordance with additional embodiments of the inventive disclosures made herein and system configured for carrying out such methods provide investors or users having access to such methods including or using a decision-assistance platform. The decision-assistance platform enables investors or users to formulate and coordinate solutions to their needs, product research, comparative assessment, implementation and acquisition. It will be appreciated that the inventive embodiments contemplate allowing an individual investor or user to bypass any financial advisors or consultants to directly empower the investor or user to make investment choices/selections. It will be appreciated that the scoring and ranking of mutual funds, ETFs, money managers, and other financial products, using this methodology effectively filters out all conflicts of interest which have too often corrupted investment advice and recommendation and has degraded investment performance.

Furthermore, methods and systems in accordance with embodiments of the inventive disclosures made herein are designed to address a number of increasingly important and troubling trends that both consumers and professional advisory firms are now facing. The growing complexity and range of available choices is creating increasing uncertainty and stress among clients and their advisors (i.e., those individuals trying to help them make informed decisions with regard to product selection), and is increasing the need for unbiased, trustworthy information and/or advice. As the range of available choices continues to proliferate and as the volume and complexity of information about them continues to grow, many investors and advisors simply do not have the time to become objectively knowledgeable about the full range of what their choices are, much less having the time and the ability to confidently choose from among them. In essence, many investors no longer have the time or individual ability to be able to discern what is truly “best” for them and their families relative to investment choices nor, for the same reasons, can advisors readily objectively determine what is best for their clients.

With rapidly expanding access to an increasingly diverse array of financial products and service choices, as well as increasingly voluminous and complex information about such choices, investors increasingly need help in objectively analyzing the universe of available investment choices in order to feel secure that they have done “the best” for themselves and their families. Embodiments of the inventive disclosures made herein provide solutions to increasingly broad needs for objective, trustworthy advice and individual self-help. The significance of this solution will continue to grow in parallel with the growth and development of the knowledge-based economy and e-commerce. With proper methodologies, training, technological tools and support, affiliated trusted advisors who already possess the greatest degree of client trust will be able to successfully meet this expanding client need for more broad ranging, objective advice with respect to financial products, and individual investors (without the assistance of advisors newly equipped in this way) will be able to objectively determine what is best for themselves and their families from all of the available choices.

The preceding describes use of the decision-assistance embodiments in the context of the financial services marketplace for individual investment choices or financial consulting to answer this key question: “Of all of the available choices, which one is best for my client or for me?” With over 20,000 mutual funds (each with over 300 tracked performance factors), 5,000-6,000 separate account managers, and thousands of other products, answering that key question is made possible using hierarchical arrayed blends of weighted performance factors including one or more AI system inputs to best match the needs, goals, and preferences of individual investors to quantitatively score and rank thousands of choices and, if desired, qualitatively use one or more AI systems to perform a qualitative due diligence review to further facilitate the selection or elimination of any score and ranked choices. It will be appreciated that there are multiple applications for use of the decision-assistance technology provided by decision engines 408, 410 with one or more AI systems or associated AI outputs, platforms, networks, nodes or device or nodes beyond the financial services marketplace. It will be appreciated that AI systems or associated AI outputs, platforms, networks, nodes or device or nodes according to the embodiments of the present disclosure may include chatbots, expert systems, machine learning systems/devices, general intelligence, general purpose or generative AI systems. The following paragraphs will describe examples of applications not only in the financial services marketplace but also different applications wherein other decision criteria and distinguishing characteristics may be used in lieu of performance criteria and decision factors may be used in lieu of performance factors. It will be appreciated that the decision criteria and decision factors are selected and used based upon the application. Decision engines 408, 410, with one or more AI systems or associated AI outputs, platforms, networks, nodes or device or nodes DTC's patented decision-assistance technology, can be given great influence or virtually no influence on the scoring and ranking of the choices, at the complete discretion of the user enables users to pick any number of distinguishing features, hierarchically blend and weight them, in order to score and rank thousands of choices; and, most importantly, it empowers users to provide, select, adjust criteria or factor weightings to do it their way. In this manner, consumers/customers/users can use decision engines 408, 410 with one or more AI systems or associated AI outputs, platforms, networks, devices or nodes to score and rank any product or choice to identify which ones have the best composite blend that users can select and weight in relative importance to them.

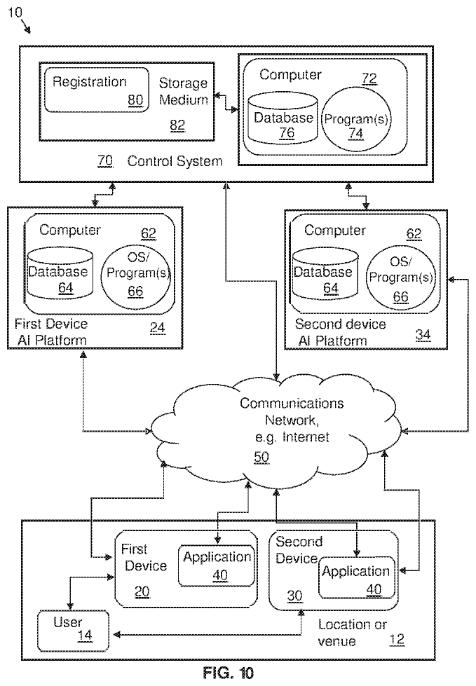

Referring now to FIG. 10, system 10 according to an embodiment of the present disclosure shows a location or venue 12 from which a user 14 controls multiple AI systems. Multiple AI devices, first device 20 and second device 30, as shown in FIG. 10, communicate with AI systems, respectively, first AI system platform 24, and second AI system platform 34, operating on respective platforms. The platforms are enabling for the multiple AI systems and the devices that employ them. It is understood that the first and second AI systems are shown as an embodiment of a plurality of AI systems and devices related to those system as an example (for simplicity of explanation in this specification), and a greater number of devices and related systems can be employed. The first and second AI platforms 24, 34, respectively, include a computer 62, database 64, and operating systems and programs 66. These features are shown generically for both systems.

The methods and systems according to an embodiment of the present disclosure, can be incorporated in one or more computer programs or an application and stored on an electronic storage medium. It is envisioned that the application can access all or part of instructions necessary to implement the method of the present disclosure. The program or application can communicate with a remote computer system via a communications network 50, e.g., the Internet, and access data, and cooperate with program(s) stored on the remote computer system. In the embodiment of the disclosure shown in FIG. 10, an application 40 stored on the first and second devices 20, 30, respectively can communication with a control system 70 via a communications network 50. The control system 70 includes a computer 72 having a database 76 and one or more programs 74. In the embodiment of the disclosure shown in FIG. 10, application 40 communicates with the control system 70 and the one or more programs 74. The control system includes computer 72 which also has access to the database 76. The control system 70 includes the first decision 408 and/or second decision engine 410 previously disclosed. For example, programs 74 and/or database 76 and/or storage medium 82 may include first and/or second decision engines 408, 410. The control system 70 also includes a storage medium 82 for maintaining a registration 80 of AI systems which are compatible for collaboration and interacting with first and/or second decision engines 408, 410. In an embodiment, the method and system which incorporates the present disclosure includes the control system (generally referred to as the back end) in combination and cooperation with a front end of the method and system, which is the application. The application is stored on a device and can access data and additional programs at the back end of the application.

The control system determines AI systems which are compatible and capable of sharing information at the location. The AI systems can be used or registered using the control system. Registration or use can include a make and model of the devices, or an operating system, so that the control system can assess the AI system for compatibility. Such registration or use can be initiated by a user or can be automatically driven based on system compatibility. Registering or using the AI systems controlled by the control system enables detecting of the decision assistance request or question at one or more of the AI systems, respectively. The control system registers, uses or interacts with the AI systems and stores the information of devices, corresponding AI systems, decision criteria and decision factors (e.g. the performance criteria and performance factors previously described) in the database 76 and/or storage medium 82 of the control system 70. Additionally, regarding registration, use or interacting with multiple AI systems, the device that received the instruction or request, can be considered a first AI system, and can communicate with another device and its AI system, which can be considered a second AI system. Such second systems can be considered secondary systems, and the first AI system can communicate with a plurality of secondary AI systems. The control system can register, use or interact with the secondary systems. The registration of, use of and interaction with the first AI system and the secondary systems can include registering of, use of and/or interaction with the AI system and its associated device or devices. In one embodiment, each AI system, platform, network, node or device or nodes can be a decision factor in the hierarchical weightings structure shown and described in connection with FIGS. 8B and 8C. It will be appreciated that the decision criteria and/or decision factors may be all AI systems and system inputs, all non-AI systems or a mix of AI and non-AI systems and system inputs. A user controls the degree of influence of each AI system, in the scoring and ranking of choices (both investment choices and choices in other applications described above), by selecting weighting values for decision factors and/or decision criteria associated with each AI system and system input and a comparative assessment for the choices is generated by decision engine 410 based on the user selected weightings and resulting composite choice scores and rankings.

In this manner, decision engines 408, 410 in control system 70 can be used by a user to control multiple AI systems and system inputs, a mix of AI and non-AI systems or multiple non-AI systems and inputs as decision factors to score and rank choices for the making of selection decisions and ongoing performance monitoring.

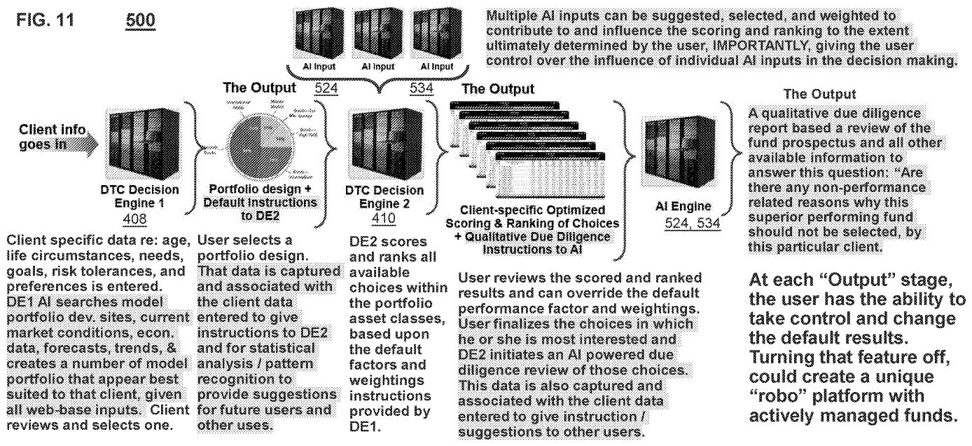

An information flow schematic 500 showing multiple embodiments in accordance with the inventive disclosures made herein is depicted in FIG. 11. Entities within the information flow schematic 500 include first decision engine 408 and a second decision engine 410 as previously disclosed in connection FIGS. 1-9 but now also shows one or more AI systems 524, 534 or associated AI outputs, platforms, networks, nodes or devices, nodes 524, 534 interacting with first and second decision engines 408, 410. AI platforms 524, 534 may be or include the first and second AI platforms 24, 34 and the entities shown in 500 may be used or controlled by user 14 within system 10 as shown and described in FIG. 10.

In one embodiment one or more AI systems or associated AI outputs, platforms, networks, nodes or devices, nodes are used to perform qualitative due diligence after the second decision engine 410 scores and ranks all available choices within the portfolio asset classes, based upon the default factors and weightings instructions provided by a user (e.g. user weighting value(s)) or the first decision engine 408. A user (e.g. and advisor or client) reviews the scored and ranked results and can override the default decision factor and weightings. A user finalizes the choices in which he or she is most interested and one or more AI systems or associated AI outputs, platforms, networks, nodes or devices, nodes performs an AI-powered due diligence review of those choices generated by the second decision engine 410. For example, this AI powered due diligence review may include a review of each fund's prospectus and all other available information to answer this question: “Are there any non-performance related reasons why this superior performing fund should not be selected?” It will be appreciated that the AI-powered due diligence may be performed by a user using one or more chatbots. For example, a user may use AI powered chatbots to determine whether investment choices meet ESG (Environment, Social, and Governance) goals, objectives, scores or compliance by among, other things, determining and/or analyzing the holdings of a fund as disclosed in a fund's prospectus or from other sources.

In another embodiment, the data used for input to or data from the output of the first decision engine 408 is also captured and associated with the client data entered to give instruction/suggestions. For example, a user enters user specific data re: age, life circumstances, needs, goals, risk tolerances, and preferences into the first decision engine 408. First decision engine 408 may include one or more AI systems or associated AI outputs, platforms, networks, nodes or devices, nodes which search model portfolio development sites, current market conditions, econ. data, forecasts, trends, etc. and outputs, returns, displays or creates a number of model portfolios that appear best suited to that user, given all web-based inputs. A user reviews and selects one of the outputs or designed model portfolios. Some or all of this previous data is captured and associated with the user data entered to give instructions to the second decision engine 410 and for statistical analysis/pattern recognition to provide suggestions for future uses by the user or other users or other uses. As shown in FIG. 11, multiple AI system inputs can be suggested, selected, and weighted to contribute to and influence the scoring and ranking by the second decision engine 410 to the extent ultimately determined and/or adjusted by the user, giving the user control over the degree of influence of each of the individual AI inputs in the decision making. In one embodiment, each AI system, platform, network, node or device or nodes can be a factor in the hierarchical weightings structure shown and described in connection with FIGS. 8B and 8C.

It will be appreciated that the first decision engine 408 may be and/or include one or more chatbots. Chatbots are increasingly used to initiate and hold automated conversations with users of websites or software via chat messaging software, obviating the need for humans to respond at least at an initial stage to chat messages presented from users via the chat messaging software. As advances in natural language processing, computational linguistics, expert systems, artificial intelligence, and machine learning make conversations between humans and chatbots more and more indistinguishable from conversations exclusively between humans, more needs can be satisfied by chatbots without requiring human intervention. Presented are a method, a system, and a computer program product for using a plurality of chatbots to each handle user messages presented in an efficient manner.

“Chat messages” as discussed herein refer to text-based, vocal, or image-based messages transmitted in real-time via chat messaging software over any sort of network (such as the internet) between a sender and a receiver. All specific types of chat messaging software, as well as all software protocols for sending and receipt of chat messages are contemplated for usage with the presently disclosed invention. In the situation that received chat messages are vocal in nature (i.e., spoken via human voice), speech recognition software serves to parse the vocal messages into text-based messages for further processing as discussed below. Alternately, if transmitted chat messages are text-based in nature, text-to-speech software may serve to convert text-based messages to vocal, as needed.

For example, a user may enter user specific data re: age, life circumstances, needs, goals, risk tolerances, and preferences into one or chatbots fulfilling the role, capacity and/or function of the first decision engine 408. Such chatbots are used by a user to search model portfolio development sites, current market conditions, econ. data, forecasts, trends, etc. and outputs, returns, displays or creates a number of model portfolios that appear best suited to that user, given all web-based inputs. A user reviews and selects one of the outputs or designed model portfolios. Some or all of this previous data is captured and associated with the user data entered to give instructions to the second decision engine 410 and for statistical analysis/pattern recognition to provide suggestions for future uses by the user or other users or other uses.

In the present embodiments, AI systems or associated AI outputs, platforms, networks, nodes or devices, nodes may be used in first and/or second decision engines 408, 410 to provide a “better” and more valuable experience for the user. In this manner, first and/or second decision engines 408, 410 may provide statistically significant information, at scale, from which patterns of user, investment advisor or client/individual investor behaviors can be recognized, and effects predicted capturing information about such interactions, to “learn” how to improve them.

As shown in FIG. 11, the output of any number of AI systems or associated AI outputs, platforms, networks, nodes or device or nodes can be incorporated as factors or elements and assigned the degree of influence (weight) the user believes each should receive. In this manner, decision engines 408, 410 incorporate and use the results of multiple other AI platforms or associated AI outputs, platforms, networks, nodes or device or nodes. The outputs or results from each AI system are configured to be elements in the hierarchical blends of weighted factors deemed important to the user such that each AI system, individually or collectively, do not supplant the human user's decision making or control of the decision making process. Instead, each AI system becomes a controlled element. For each AI system output, the user can take control and change the default results by assigning a user's selected weighting such that the decision-assistance technology provided by decision engines 408, 410. A user controls each AI system by selecting and/or adjusting weighting values for decision/performance factors and/or decision/performance criteria associated with each AI system and a comparative assessment for the choices is generated by decision engine 410 based on the user selected and/or adjusted weightings and resulting composite choice scores.

Example #1 (Horserace Handicapping). The key question in horserace handicapping is essentially the same and, with the decision-assistance technology provided by decision engines 408, 410 with one or more AI systems or associated AI outputs, platforms, networks, nodes or device or nodes, users could select any number of distinguishing characteristics, hierarchically blend and weight them to comparatively evaluate (score and rank) any number of choices, specific to their own individual beliefs and preferences in any race anywhere (both at the track and off). They could then better compete with, and possibly even rival, the pros. Previous attempts to handicap horses using weighted factors have fallen short of the goal, principally because of too many factor choices, too much information/complexity, and still no way to deal with it quickly and easily, especially in the limited time between races. The decision-assistance technology provided by decision engines 408, 410 with one or more AI systems or associated AI outputs, platforms, networks, nodes or device or nodes can help achieve the goal of giving bettors the ability in real time to comparatively evaluate the data on all race-day choices, score and rank horse/jockey/track combinations in a manner specific to each bettor's preferences, and then help evaluate which bets to place. If combined/integrated with an online betting platform, it would also give bettors the ability to place those bets quickly and easily, from any location. One or more of the AI systems can be used to provide bettors with a degree of insight and understanding of the dynamics/results of both their own betting as well as the betting patterns/success of others.

Example #2 (Online Car Shopping). Online car/vehicle/automotive shopping is a multi-billion-dollar industry ripe for disruption. The automotive shopping experience has long failed to protect and empower car buyers, principally because of too many choices, too much information/complexity, and no way to deal with all of that quickly and easily, especially with geographic limitations, highly competitive OEM incentives, and back-room dealing between sales and finance, among many other factors. In contrast, decision engines 408, 410 with one or more AI systems or associated AI outputs, platforms, networks, nodes or device or nodes can help to solve these problems, by using hierarchical arrays of weighted factors to enable the user to objectively score and rank available choices to identify those that best match the users' needs, goals, and preferences. The result: a better and more enjoyable experience for car shoppers and a new tool with which OEMs and auto dealers can compete with and distinguish themselves from their competition.

Example #3 (Regulatory Compliance/RegTech/United States Department of Labor Compliant Process). Recently proposed or promulgated United States Securities and Exchange Commission and Department of Labor Rules (“DOL Rules”), as well as the Rules and Regulations of various states, make it a requirement that a “process” be employed that will establish/demonstrate that stocks, bonds, mutual funds, annuities and other investment products that have been offered and sold to the purchaser are in the purchaser's “best interests.” Annuity sales have, to a very large extent, been traditionally commission driven, and higher commission products are typically considered to be in the “best interests” of the product salesperson and not the purchaser of the product. Independent Marketing Organizations (“IMO”)/suppliers of annuity products, are or may soon be within the chain of expanded potential liability under the new Rules in which the key question becomes: “How can we avoid/protect ourselves from this new potential liability that the sales activities of our agents/reps could cause?” Decision engines 408, 410 with one or more AI systems or associated AI outputs, platforms, networks, nodes or device or nodes mandate that a “process” be employed to establish/demonstrate that what has been offered and sold is the “best interests” of the purchaser by providing purchasers with lists of available annuities scored and ranked according to their individual needs, goals, and preferences. This objectively and transparently ensures that the purchaser is getting to see which of the available annuities best matches his or her needs, goals, and preferences—in other words, which of them is in the purchaser's “best interests.” All of this equally applies to the investment advice and mutual fund, ETF, and investment manager recommendations provided by investment advisors and securities brokers to the clients/customers, discussed above.

Example #4 (Election/Voting/Fundraising). Is there an even better way to manage and use the data about prospective voters/donors? Using hierarchically weighted blends of factors will allow campaigns to further fine tune their “ground games” and fundraising in ways not previously available-improving prospective donor targeting, improving targeting for voter registration, and improving the ground game/legal ballot harvesting/voting by mail/getting out the vote efforts. With limited field resources, which prospective voters do we contact? Decision engines 408, 410 with one or more AI systems or associated AI outputs, platforms, networks, nodes or device or nodes can help to solve these problems, by using hierarchical arrays of weighted factors to enable the user to objectively score and rank available factors (e.g. voter historical data, voter financial data etc.) to identify those that best match the users' needs, goals, and preferences. The speed and ease with which this can be done makes, real time and in-the-field application possible.

Example #5 (On-line Shopping/Comparative Product Evaluations/Customer Reviews). Online shoppers must be offered a compelling reason to go to a site. One compelling application that online shoppers need and will want is the ability to answer this simple question—“Of all the available choices, which one is best for me?”—by comparatively evaluating their choices in a manner specific to their own personal needs, goals, and preferences, before they buy. Today's online shoppers face an increasingly bewildering array of product choices and information about them, and they have no meaningful way to comparatively evaluate them. There is currently no way for them to answer the simple, yet increasingly important, question posed above. For example, if you “Google” virtually any product, you will find companies that make that product and places that sell it, but you won't find a site where you can comparatively evaluate it. Yes, you can find sites that “rate” or “rank” products (Consumer Reports is likely the best known of these), but all have one serious flaw in common . . . they “rank” product choices “their way.” The factors they use may not match your needs and preferences. Some may even disclose the factors they use to produce their “rankings,” but you cannot change them. You cannot make them “yours.” In contrast, decision engines 408, 410, with one or more AI systems or associated AI outputs, platforms, networks, nodes or device or nodes DTC's patented decision-assistance technology, can be given great influence or virtually no influence on the scoring and ranking of the choices, at the complete discretion of the user to enable users to pick any number of distinguishing features, hierarchically blend and weight them, in order to score and rank thousands of choices; and, most importantly, it empowers users to do it their way. In this manner, consumers/customers/users can use decision engines 408, 410 with one or more AI systems or associated AI outputs, platforms, networks, devices or nodes to score and rank any product . . . to identify which ones have the best composite blend of price/features/and other metrics (even pundit opinions and user reviews) that individual shoppers can select and weight in relative importance to them.

Example #6 (Fantasy Sports/Fantasy Football). In this application, fantasy sport or fantasy football participates/bettors can use decision engines 408, 410 with one or more AI systems or associated AI outputs, platforms, networks, devices or nodes to score and rank any player or team choices . . . to identify and select fantasy football/sports players which ones have the best composite blend of playing/positional statistics and other metrics (even scouting and/or pundit opinions) that individual participates/bettors can select and weight in relative importance to them. For example, weighted factors from player statistics could include receptions, receiving yards, receiving TDs, rushing yards, rushing TDS and fumbles.

Other Applications/Examples. Some applications could include cryptocurrencies, commodities, insurance policies, streaming services to allow a user to make choices based on a user's preferences as opposed to the sales recommendations and “advice” of third parties or AI systems selecting for the user with no way for the user to control the resulting output or understand how the resulting recommendation/advice was selected.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized, and that logical, mechanical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyrights whatsoever. The systems described herein with respect to individual business organizations can also be used by groups/business entities to obtain rate quotes for insurance sold to groups/business entities. The architecture, programs, processes, methods and systems described herein are not related or limited to any particular type of computer or network system (hardware or software), unless indicated otherwise. Various types of general purpose or specialized computer systems may be used with or to perform operations in accordance with the teachings described herein. In view of the wide variety of embodiments to which the principles of the present disclosure can be applied, the illustrated embodiments are exemplary only and should not be taken as limiting the scope of the present disclosure. For example, the steps of the flow diagrams may be taken in sequences other than those described, and more or fewer elements may be used in the block diagrams. While various elements including, but not limited to, embodiments have been described herein as being implemented in software, in other embodiments hardware or firmware implementations may alternatively be used, and vice-versa. The claims should not be read as limited to the described order or elements unless stated to that effect. Use of the term “means” in any claim is intended to invoke 35 U.S.C. § 112, paragraph 6 and any claim without the word “means” is not so intended.

What is claimed is:

1. A computer system comprising:
a computer processor, a computer-readable storage medium, and program instructions stored on the computer-readable storage medium being executable by the processor, to cause the computer system to perform a method for user control of multiple AI (Artificial Intelligence) systems for comparatively assessing choices, comprising:
communicating and interacting with multiple AI systems;
using a hierarchical weighting structure including a plurality of decision criteria and a plurality of decision factors wherein each of said multiple AI Systems are at least one of the decision factors selected to provide a desired effect;
selecting a weighting value for each one of said decision criteria and for each one of said decision factors selected to provide the desired effect;
providing a plurality of choices on which to perform a comparative assessment;
deriving a composite choice score from said decision factor values and the corresponding relative weighting value for each one of said decision criteria for each one of said choices; and
providing a comparative assessment for the plurality of choices at least partially based on the composite choice scores.

2. The computer system of claim 1 wherein the selecting a weighting value step includes selecting at least one of said weighting values, by a user, to provide the desired effect.

3. The computer system of claim 1 wherein the selecting a weighting value step includes adjusting, by a user, at least one of said weighting values to provide the desired effect.

4. The computer system of claim 1 wherein the selecting a weighting value step includes selecting a user weighting value for at least one of said weighting values to provide the desired effect.

5. A system for comparatively assessing investment choices, comprising:
at least one data processing device;
instructions processable by said at least one data processing device; and
an apparatus from which said instructions are accessible by said at least one data processing device wherein said instructions are configured for causing said at least one data processing device to:
provide a hierarchical weighting structure including a plurality of performance criteria and a plurality of performance factors selected to provide a desired investment effect, wherein a first group of said performance factors subtends from a first one of said performance criteria, a second group of performance factors subtends from a second one of said performance criteria, the plurality of performance criteria comprises at least risk and return associated with said investment choices, and the plurality of performance factors are at least time-based measurements of said performance criteria;
provide a relative weighting value for each one of said performance criteria and for each one of said performance factors selected to provide the desired investment effect;
provide a plurality of investment choices on which to perform a comparative assessment;
provide a performance factor value corresponding to each one of said performance factors for each one of said investment choices; derive a composite investment performance score from said performance factor values and the corresponding relative weighting value for each one of said performance criteria for each one of said investment choices;
initiate, using one of more AI systems, a due diligence review for said investment choices; and
provide a comparative assessment for the plurality of investment choices at least partially based on the composite investment performance scores and the AI system due diligence review.

6. The system of claim 5 wherein the AI system due diligence review is performed using one or more chatbots.

7. The system of claim 5 wherein said instructions are configured for causing said at least one data processing device to provide at least one of said relative weighting values, by a user, to provide the desired effect.

8. The system of claim 5 wherein said instructions are configured for causing said at least one data processing device to adjust, by a user, at least one of said weighting values to provide the desired effect.

9. The system of claim 5 wherein said instructions are configured for causing said at least one data processing device to provide at least one user weighting value for at least one of said weighting values, by a user, to provide the desired effect.

10. A system for comparatively assessing investment choices, comprising:
at least one data processing device;
instructions processable by said at least one data processing device; and
an apparatus from which said instructions are accessible by said at least one data processing device;
wherein said instructions are configured for causing said at least one data processing device to: create, using one of more AI systems, one or more model portfolios for investment choices;
provide a hierarchical weighting structure including a plurality of performance criteria and a plurality of performance factors selected to provide a desired investment effect, wherein a first group of said performance factors subtends from a first one of said performance criteria, a second group of performance factors subtends from a second one of said performance criteria, the plurality of performance criteria comprises at least risk and return associated with said investment choices, and the plurality of performance factors are at least time-based measurements of said performance criteria;
provide a relative weighting value for each one of said performance criteria and for each one of said performance factors selected to provide the desired investment effect;
provide a plurality of investment choices, dependent on the one or more model portfolios, on which to perform a comparative assessment;
provide a performance factor value corresponding to each one of said performance factors for each one of said investment choices;
derive a composite investment performance score from said performance factor values and the corresponding relative weighting value for each one of said performance criteria for each one of said investment choices; and
provide a comparative assessment ranking the plurality of investment choices, for each model portfolio, at least partially based on the composite investment performance scores.

11. The system of claim 10 wherein said instructions are configured for causing said at least one data processing device to initiate, using one of more AI systems, a due diligence review for said investment choices; and provide a comparative assessment for the plurality of investment choices at least partially based on the composite investment performance scores and the AI system due diligence review.

12. The system of claim 10 wherein said instructions are configured for causing said at least one data processing device to create, using one of more AI systems, one or more model portfolios for investment choices are created, by a user, using one or more chatbots.

13. The system of claim 10 wherein said instructions are configured for causing said at least one data processing device to provide at least one of said relative weighting values, by a user, to provide the desired effect.

14. The system of claim 10 wherein said instructions are configured for causing said at least one data processing device to adjust, by a user, at least one of said weighting values to provide the desired effect.

15. The system of claim 10 wherein said instructions are configured for causing said at least one data processing device to provide at least one user weighting value for at least one of said weighting values, by a user, to provide the desired effect.

16. The system of claim 10 wherein said instructions are configured for causing said at least one data processing device to communicate and interact with multiple AI systems and to use the hierarchical weighting wherein each of said multiple AI Systems are at least one of the decision factors selected to provide a desired effect.
